(19) United States
(12) Patent Application Publication
(10) Pub. No.: US 2006/0172053 A1
(43) Pub. Date: Aug. 3, 2006

(54) Reduced sugar sweet roll

(76) Inventors: Patricia W. Hahn, Plymouth, MN (US); Susan H. Messick, Lakeville, MN (US); Cara J. Sekerak, Lakeville, MN (US); Michael D. Engesser, Coon Rapids, MN (US)

Correspondence Address: GENERAL MILLS, INC., P.O. BOX 1113, MINNEAPOLIS, MN, 55440, US

(21) Appl. No.: 11/338,082

(22) Filed: Jan. 24, 2006

Related U.S. Application Data
(60) Provisional application No. 60/647,043, filed on Jan. 24, 2005.

(51) Int. Cl. A21D 10/00

(52) U.S. Cl. 426/549

(57) ABSTRACT

A low or no sugar sweet roll product or intermediate is provided wherein at least a portion of the sweetness of the sweet roll product is provided by a non-nutritive sweet flavorant provided in combination with at least one sugar alcohol having a molecular weight less than about 350. Additionally, specific formulations of non-nutritive sweet flavorant with defined sugar alcohols and/or polydextrose are provided when the non-nutritive sweet flavorant and sugar alcohol is in the filling component or the icing component of the sweet roll product or intermediate.

This application claims the benefit of U.S. Provisional Application Ser. No. 60/647,043, filed Jan. 24, 2005, entitled “REDUCED SUGAR SWEET ROLL,” which application is incorporated herein by reference in its entirety.

### FIELD OF THE INVENTION

The invention relates to sweet rolls. More specifically, the invention relates to sweet rolls having little or no sugar.

### BACKGROUND

Consumers commonly enjoy the convenience of packaged food products such as dough products. In particular, unbaked or partially baked dough products have gained commercial success as provided in frozen or refrigerated forms to facilitate consumers making home-baked dough products. The preparation of such products, particularly within a home environment, can serve many useful and/or desirable functions. First of all, refrigerated or frozen dough products are convenient. In most cases, consumers can prepare fresh baked goods in the home in a matter of minutes simply by unwrapping, separating and baking the dough products. Secondly, the preparation of such dough products can serve to provide entertainment for those who enjoy cooking these items, a sense of satisfaction to those who enjoy preparing such items, and furthermore, can create a comfortable, “homey” atmosphere by virtue of the aroma that is produced when these items are baked. Such refrigerated or frozen dough products also find value in commercial settings, such as in in-store bakeries and restaurants that bake sweet rolls for consumption by customers.

Many refrigerated dough products contain fillings within the dough, e.g., cinnamon or fruit fillings, which are desirably moist in appearance and taste. However, including an amount of moisture, i.e., in the form of water, fruit juice, or other consumable liquid, necessary to impart these desirable characteristics to the filling presents many difficulties to the manufacturer of such products. That is, fillings with a high moisture content typically will have a low viscosity and will tend to be very fluid, rendering them difficult to apply to dough products in a manufacturing setting. Furthermore, once so applied, the filling can impart a slipperiness to the dough product, and thus, can make it difficult to form the dough into shapes around the filling. Finally, once packaged, these dough products are typically stored for relatively long periods of time, i.e., during transport from the manufacturer to the retail environment, retail shelf time, and in storage at the end user facility. Such long periods of storage are generally not well tolerated by dough products including a high moisture filling, as the moisture has a tendency to migrate between the filling and the dough and/or into the packaging. Moisture migration between the filling and the dough can adversely affect the quality of the filling, as well as the dough, and thus, the overall dough product quality can suffer.

In addition to the problems that dough products including such desirable high moisture fillings present to the manufacturer of such products, such dough products can also prove problematic for the end-user to prepare and/or once so prepared, can result in suboptimal baked dough products. That is, moisture migration from the filling into the packaging can result in liquid pooling within the packaging which, in turn, can render the dough product slippery and difficult for the end-user to handle. Additionally, when these dough products are baked, further moisture migration may result in a degradation of the quality of the filling, as well as in the quality of the baked product surrounding the filling.

Today's health-conscious consumers wish to reduce their consumption of sugar, and particularly sucrose, for a number of reasons, including reduction of calorie intake. For this reason, sugar substitutes, sometimes called high intensity sweeteners or non nutritive sweet flavorants, have been developed. Sugar substitutes may be very effective for use in certain food products, such as soft drinks and the like. The direct substitution of sugar with non nutritive sweet flavorants in other products, such as baked goods, is more problematic. Sugar plays a number of roles in the overall flavor, texture and appearance properties of food products in addition to simply providing a sweet taste.

Rhodes International company, for example, has introduced a frozen Sugar Free Microwave Cinnamon Roll. This product uses xylitol as a sugar substitute. Because this product is frozen, the water activities of the components are not deemed to be as critical for fundamental product performance. However, even frozen products when stored for a long time or if exposed to freeze-thaw cycles may exhibit problems associated with moisture migration. Further, moisture migration may be a particular issue if the product is thawed prior to baking. Additionally, flavor and texture properties may be less than desirable with this selection of sugar substitute.

Thus, there is a need for stable, moist fillings for use in low sugar dough products, and in particular, for use in dough products that are desirably stored for prolonged periods of time. Such fillings, although desirably including an amount of moisture so as to provide them with pleasing organoleptic characteristics, would desirably not exert a substantial negative effect on the surrounding dough product during prolonged periods of storage and subsequent baking. Additionally, such fillings would desirably be readily and easily manufactured without requiring the utilization of specialized manufacturing equipment, and furthermore, would desirably have handling properties that allow them to be readily and easily incorporated into a variety of dough products.

### SUMMARY OF THE INVENTION

In addition to the concerns identified above, today's consumer has high expectations for all of the organoleptic properties of sweet rolls, and particularly desires such products to be provided a very convenient form that has low or no sugar content. Sweet rolls are expected to be sweet, and additionally have little or no undesirable aftertaste. Additionally, the total organoleptic effect of the sweet roll should be satisfactory, with no notable moisture migration issues such as syruping and the like.

It has surprisingly been found that very satisfactory low or no sugar-containing sweet rolls can be prepared suitable for long term storage in either a refrigerated or frozen format. Thus, the present invention provides a sweet roll product comprising (a) a dough component having a first water activity; (b) a non-emulsion based, moisture-containing filling component comprising at least two water activity impacting ingredients and having a second water activity, and (c) an icing component. The first water activity is greater than or equal to the second water activity, and the second water activity is at least about 0.725. The sweet roll product comprises less than or equal to about 9.75 g of sugar per 55 g sweet roll product serving. At least a portion of the sweetness of the sweet roll product is provided by a non-nutritive sweet flavorant, provided in combination with at least one sugar alcohol having a molecular weight less than about 350. For purposes of the present invention, “in combination” means that the recited compounds are provided as formulation ingredients of the same component of the product, whether they are mixed together prior to mixing with other ingredients of the product component or are added as separate ingredients for mixing with other ingredients of the product component. In the case where at least a portion of the sweetness of the sweet roll product is provided by a non-nutritive sweet flavorant in the filling component, the non-nutritive sweet flavorant is provided in combination with at least (i) one sugar alcohol having a molecular weight from about 100 to about 300 and (ii) at least one sugar alcohol having a molecular weight from about 300 to about 350 and/or at least one polydextrose. In the case where at least a portion of the sweetness of the sweet roll product is provided by a non-nutritive sweet flavorant in the icing component, the non-nutritive sweet flavorant is provided in combination with at least (i) one sugar alcohol having a molecular weight less than about 350 and (ii) at least one polydextrose, or (i) one sugar alcohol having a molecular weight from about 100 to about 300 and (ii) at least one sugar alcohol having a molecular weight from about 300 to about 350.

It has been determined that a desired amount of sugar can be eliminated from a conventional sweet roll formulation, while still maintaining the high standards of organoleptic properties. Sugar can be partially or totally eliminated from one or more of the dough, filling or icing components of the sweet roll in a manner that maintains both the desired water activities of these components, and also provides the desired hedonics of the sweet roll product.

In one embodiment, it has been found that the desired water activity and organoleptic properties can be achieved when the sweetness of the dough component of the sweet roll product is provided at least in part by a non-nutritive sweet flavorant in combination with at least one sugar alcohol having a molecular weight less than about 350. This balance of ingredients surprisingly affords both the desired flavor and water activity properties of this component of the sweet roll product. In a particularly preferred embodiment, the sugar alcohol is erythritol. It has been found that this sugar alcohol in particular affords the most effective combination of flavor and water activity control when used in combination with a non-nutritive sweet flavorant.

In another embodiment, it has been found that the desired water activity and organoleptic properties can be achieved when the sweetness of the filling component of the sweet roll product is provided at least in part by a non-nutritive sweet flavorant in combination with at least (i) one sugar alcohol having a molecular weight from about 100 to about 300 and (ii) at least one sugar alcohol having a molecular weight from about 300 to about 350 and/or at least one polydextrose. This balance of ingredients surprisingly affords both the desired flavor and water activity properties of this component of the sweet roll product. Because sugar conventionally is such a large portion of the filling component, the desired balance of water activity and organoleptic properties necessitates use of an at least three part system as noted here to provide the desired sweetness properties. In a particularly preferred embodiment, the sugar alcohol comprises erythritol, and more preferably comprises maltitol and erythritol. It has been found that these sugar alcohol systems in particular afford the most effective combination of flavor and water activity control when used in combination with a non-nutritive sweet flavorant and polydextrose.

In yet another embodiment, it has been found that the desired water activity and organoleptic properties can be achieved when the sweetness of the icing component of the sweet roll product is provided at least in part by a non-nutritive sweet flavorant in combination with at least (i) one sugar alcohol having a molecular weight less than about 350 and (ii) at least one polydextrose, or (i) one sugar alcohol having a molecular weight from about 100 to about 300 and (ii) at least one sugar alcohol having a molecular weight from about 300 to about 350. This balance of ingredients surprisingly affords both the desired flavor and water activity of this component of the sweet roll product. Because sugar conventionally is such a large portion of the icing component, the desired balance of water activity and organoleptic properties necessitates use of an at least three part system as noted here to provide the desired sweetness properties. In a particularly preferred embodiment, the sugar alcohol is maltitol. It has been found that this sugar alcohol in particular affords the most effective combination of flavor and water activity control when used in combination with a non-nutritive sweet flavorant and polydextrose, or alternatively when used in combination with a non-nutritive sweet flavorant and erythritol.

In an additional embodiment of the present invention, a frozen sweet roll product intermediate is provided comprising
(a) a dough component having a first water activity; and
(b) a non-emulsion based, moisture-containing filling component comprising at least two water activity impacting ingredients and having a second water activity,

wherein the first water activity is greater than or equal to the second water activity, and the second water activity is at least about 0.725; and

at least a portion of the sweetness of the sweet roll product is provided by a non-nutritive sweet flavorant provided in combination with at least one sugar alcohol having a molecular weight less than about 350; and

when at least a portion of the sweetness of the sweet roll product is provided by a non-nutritive sweet flavorant in the filling component, the non-nutritive sweet flavorant is provided in combination with at least (i) one sugar alcohol having a molecular weight from about 100 to about 300 and (ii) at least one sugar alcohol having a molecular weight from about 300 to about 350 and/or at least one polydextrose, or at least (i) one sugar alcohol having a molecular weight from about 300 to about 350 and (ii) polydextrose. It has particularly been found that frozen sweet roll products and be formulated using fillings that do not need to utilize the sugar alcohol having a molecular weight from about 100 to about 300. Fillings formulated in particular using at least (i) one sugar alcohol having a molecular weight from about 300 to about 350 and (ii) polydextrose have been found to have satisfactory performance properties in water activity and other organoleptic properties when the sweet roll intermediate or product is provided and stored in the frozen environment. Such intermediate products may additionally be provided with icing, as a separate component of an intermediate kit, or as a frozen sweet roll product comprising the above described frozen sweet roll intermediate and with icing applied thereto.

In an exemplary embodiment, the sweet roll of the invention has a calorie content of less than about 180 calories per 55 grams of sweet roll product.

The present invention additionally provided sweet roll intermediate products comprising dough and filling, with water activities of the respective components as defined herein. The icing component used to provide the complete sweet roll product may optionally be provided as a completely separate component.

For purposes of the present invention, the “sugar” to be provided in the sweet roll product of the present invention in little or no amount is defined as free mono- and disaccharides (such as glucose (dextrose), fructose, lactose, maltose, and sucrose).

### DETAILED DESCRIPTION

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

The present invention provides non-emulsion based fillings and dough products incorporating the fillings that are extremely stable. By forming a dough product from a filling and a dough with substantially equivalent water activities, moisture migration within, or out of, the dough product is discouraged so as to be substantially reduced or eliminated. That is, there is a reduced tendency for moisture to migrate between the filling and the dough in efforts to achieve an equilibrium state. As a result of the reduction or elimination of moisture migration, a filling having a desirable moisture level can be made where the product quality of the filling, the dough and dough product is not substantially degraded, and in fact, can remain substantially unchanged during storage and subsequent cooking. Thus, when the dough product is cooked, a baked dough product with excellent visual and organoleptic properties can be obtained.

The moisture migration that typically occurs in conventional filled dough products between the filling and the dough occurs at least in part due to the relatively large differential, i.e., 0.25 or greater, that typically exists between the water activity of the dough and the water activity of the filling. When such a high differential exists, moisture will have a greater tendency to migrate between the dough and the filling in a manner similar to the manner in which the concentration of a gas in solution will come to equilibrium with the concentration of gas above the solution when in a closed environment.

The water activities of the dough component and the filling component are in one embodiment selected so that the differential between the first water activity and the second water activity is less than about 0.25, in another embodiment less than 0.2, and in yet another embodiment less than about 0.15.

As used herein, the phrase “water activity” or “Aw” with respect to a filling, a dough, or a dough product, is meant to indicate the ratio of the vapor pressure of the filling, dough or dough product, to the vapor pressure of pure water at any given temperature. Thus, pure water has a water activity of 1. Water including any other component, such as sugar or salt, will have a water activity of less than 1. Water activity can be measured by, e.g., enclosing the sample desirably measured in an enclosed space. Once equilibrium is reached, the relative humidity above the sample can be measured, which measurement is indicative of the water activity of the sample. Such measurements can be made, e.g. as by a water activity meter such as that commercially available from Decagon Devices, Inc., Pullman, Wash.

Also as used herein, the phrase “substantially equivalent” as used in conjunction with the water activities of a filling in accordance with the present invention and a dough, is meant to indicate that a low differential, e.g., less than about 0.25, exists between the water activities. Additionally, the phrase “water activity-impacting ingredient” is meant to indicate an ingredient that, by virtue of its inclusion in the fillings of the present invention, can act, either directly or indirectly, to alter the water activity of the filling. That is, in some instances, as is the case with sugar, the inclusion of the ingredient will itself act to alter, and typically lower, the water activity of the filling, while in others, the inclusion of the ingredient, e.g., as is the case with fat or a viscosity controlling agent, allows for the inclusion of a greater amount of moisture which in turn has the effect of raising the water activity of the filling. Both ingredients that act directly, as well as those that act indirectly, to impact the water activity of the filling are considered to be within the scope of the term “water-activity impacting ingredient.” Finally, the phrase “organoleptic properties” as used herein is meant to indicate those properties, whether visual, textural or taste properties that contribute to the overall quality of a dough product. For example, organoleptic properties are typically meant to include such properties as taste, color, smell, texture, shape, appearance, mouthfeel, smoothness, and the like.

For purposes of the invention, a non-nutritive sweet flavorant is a component that provides a sweet taste to the final product, where the component contributes no calories or where the component does contribute calories, but possesses a sweetness potency that is so high that their extremely low usage level imparts no significant impact on the final product's caloric content. Preferred non-nutritive sweet flavorants are selected from the group consisting of saccharin, aspartame, acesulfame potassium, sucralose, cyclamate, neotame, alitame and mixtures thereof.

The first component of the sweet roll as described herein is the dough. The dough may be made from any formulation suitable for the desired sweet roll product. Conventional rolls are made from a dough comprising flour, water, fat, gluten, emulsifier, leavening, salt and sweetener. Other additives that may optionally be utilized in the doughs of the present invention include, for example: salt; whiteners, such as titanium dioxide; anti-microbial agents, such as potassium sorbate, sorbic acid, dehydroacetic acid, sodium benzoate, and the like; sequestering agents; acidulants; buffers; food acids; preservatives; processing aids, such as emulsifiers; antioxidants, such as butylated hydroxytoluene, butylated hydroxyanisole, and the like; as well as vitamins and minerals.

Such doughs may be readily formulated in a manner known to the skilled artisan. Examples of such dough formulations included those suitable for use as doughnuts, Danishes, toaster pastries, coffeecakes, sweet rolls, Bismarcks, cookies, bagels, biscuits, scones, dinner rolls, breads, croissants, egg twists, bread sticks, and the like. Formulations of such dough products, in addition to being well known to those of ordinary skill in the art, are also described in a voluminous number of commercially available references. Such doughs typically have water activities of 0.90 or greater.

The dough may optionally be formulated to naturally have a small amount of sugar in the dough without use of a non-sugar sweetening agent. If a sweeter dough is desired, sugar may be added as a component of the dough formulation. Such doughs are particularly desirable where an overall sweet organoleptic effect is desired throughout the product, rather than isolated at the filling or icing components of the sweet roll.

In an embodiment of the present invention, the dough component of the sweet roll product is provided at least in part by a non-nutritive sweet flavorant in combination with at least one sugar alcohol having a molecular weight less than about 350. This balance of ingredients surprisingly affords both the desired sweet dough flavor and water activity properties of this component of the sweet roll product. In selected embodiments of the present invention, the sugar alcohol is selected from the group consisting of erythritol, glycerol, propylene glycol, xylitol, mannitol, sorbitol, maltitol and lactitol.

In one embodiment of the invention, the sugar alcohol is a mixture of sugar alcohols having a weighted average molecular weight of less than about 180. In another embodiment, the sugar alcohol is a mixture of sugar alcohols having a weighted average molecular weight of less than about 150.

In a particularly preferred embodiment, the sugar alcohol is erythritol. It has been found that this sugar alcohol in particular affords the most effective combination of flavor and water activity control when used in combination with a non-nutritive sweet flavorant.

The second component of the sweet roll as described herein is the filling. The filling is a non-emulsion based flavor-imparting coating composition comprising a fat, a sweetener, and optional viscosity modifiers and optional additional flavorant. Such filling compositions can be formulated in any manner suitable for application to the dough component of the desired sweet roll product, as will now be understood by the skilled artisan.

The fat(s) to be utilized in the fillings of the present invention is not particularly restricted, but rather, any fat, or combination of fats, capable of acting as a physical barrier to moisture migration is suitable for use in the present inventive fillings. The fat can be derived from any animal or plant source. One exemplary fat that has been found to be particularly well suited for use in the fillings of the present invention is partially hydrogenated vegetable shortening, but the invention is not so restricted and the fat component may also be and/or include other shortenings, margarine, butter or oils.

The sweetener to be used in a filling is conventionally sugar. However, in the product of the present invention, an embodiment comprises formulating the filling to reduce or eliminate the amount of sugar in the filling. It has been found that the sweetness of the filling component of the sweet roll product can be provided at least in part by a non-nutritive sweet flavorant in combination with at least (i) one sugar alcohol having a molecular weight from about 100 to about 300 and (ii) at least one sugar alcohol having a molecular weight from about 300 to about 350 and/or at least one polydextrose. This balance of ingredients surprisingly affords both the desired flavor and water activity properties of this component of the sweet roll product. Because sugar conventionally is such a large portion of the filling component, the desired balance of water activity and organoleptic properties necessitates use of an at least three part system as noted here to provide the desired sweetness properties.

In selected embodiments of the present invention, the sugar alcohol having a molecular weight of from about 100 to about 300 is selected from the group consisting of erythritol, glycerol, propylene glycol, xylitol, mannitol, and sorbitol; and the sugar alcohol having a molecular weight of from about 300 to about 350 is selected from the group consisting of maltitol and lactitol. In one embodiment of the invention, the sugar alcohols in the filling are selected to provide a mixture of sugar alcohols having a weighted average molecular weight of less than about 180. In another embodiment, the sugar alcohols in the filling are selected to provide a mixture of sugar alcohols having a weighted average molecular weight of less than about 150.

In a particularly preferred embodiment, the sugar alcohol comprises erythritol. It has been found that this sugar alcohol in particular affords the most effective combination of flavor and water activity control when used in combination with a non-nutritive sweet flavorant.

In yet another particularly preferred embodiment, the sugar alcohols in the filling comprise a mixture of erythritol and maltitol.

Particular filling embodiments are compositions that comprise 1-20% erythritol, 10-40% maltitol, 0-30% polydextrose, 0.01-0.4% non-nutritive sweetener, 25-50% fat, 5-25% water, 1-10% flavor, and 0.1-3% viscosity modifier.

Polydextrose is a white or milky white noncrystalline powder that is a polymer comprising D-glucose. Examples of polydextroses that can be used in the present invention include the Litesse® family of polydextroses from Danisco Sweeteners Ltd.

Viscosity controlling agents are materials that are capable of interacting or binding with water to form a colloidal mass or gel. As a result, additional moisture may be added to the fillings of the present invention, which moisture will not only have the impact of desirably raising the water activity of the filling, but also can advantageously impart a moist appearance, taste and texture to the filling.

In one embodiment of the present invention, the filling thus comprises, in addition to the amount of fat, an amount of one or more viscosity controlling agents. The particular viscosity controlling agent(s) to be utilized is not particularly restricted, but rather, any viscosity controlling agent capable of binding water to from a colloidal mass or gel, while not otherwise detrimentally affecting the organoleptic or handling characteristics of the filling, is suitable for use in the filling of the present invention. Exemplary viscosity controlling agents suitable for use in the present invention include, but are not limited to, hydrocolloid gums; gel-forming proteins such as gelatin; natural or modified starches; combinations of these and the like. Preferably, the viscosity controlling agent(s) utilized in the fillings and dough products of the present invention will be a hydrocolloid gum, such as, e.g., gellan gum, tara gum, guar gum, locust bean gum, agar, alginate, carrageenan, gum arabic, gum ghatti, gum karaya, gum tragacanth, xanthan gum, carboxymethyl cellulose, methyl cellulose, hydroxypropyl cellulose, hydroxypropylmethyl cellulose, and the like. Due to the desirable organoleptic properties provided to the filling of the present invention by virtue of its inclusion, one example of a particularly preferred hydrocolloid gum for use in the filling of the present invention is alginate.

The amount of the viscosity controlling agent to be utilized in the filling will, of course, depend upon the particular viscosity controlling agent chosen and nature of the dough product desirably being prepared. As a lower limit, at least enough of the viscosity controlling agent is desirably included to at least minimally produce the desired effect, i.e., to interact with, or form a barrier to, at least a portion of the moisture in the dough and/or filling. As an upper limit, not so much of the viscosity controlling agent should be included in the filling so that the handling properties of the filling are substantially negatively impacted, e.g., the amount of viscosity controlling agent(s) included would desirably not result in the filling being too stiff to readily and easily apply the filling to a dough product. Additionally, the viscosity controlling agent(s) will also desirably be included in an amount effective to allow the viscosity controlling agent to interact with moisture in the filling in a manner so as to inhibit moisture migration, thereby allowing more moisture to be incorporated into the filling, which in turn, will desirably at least minimally raise the water activity of the filling. Bearing these considerations in mind, and for exemplary purposes only, the amount of viscosity controlling agent to be included in the filling desirably ranges from about 0.1% to about 5%, preferably from about 0.25% to about 4% and more preferably from about 0.4% to about 3%.

Additionally, synthetic and natural flavorings or coloring agents may be utilized in the fillings of the present invention. Exemplary flavors include spices, cream or cream cheese flavor, milk powder, chocolate, vanilla extract, vanilla powder, cocoa substitute, hazelnut, dutched cocoa, mint, lemon, orange and mixtures thereof. Also, flavor materials and particulates, such as fruit (such as orange, blueberry, or any other desired flavor) and fruit extracts, nuts, maple syrup chocolate and other types of flavored chips and the like, can be added to the filling as desired. A preferred flavorant is cinnamon.

Other additives that may optionally be utilized in the fillings of the present invention include, for example: salt; whiteners, such as titanium dioxide; anti-microbial agents, such as potassium sorbate, sorbic acid, dehydroacetic acid, sodium benzoate, and the like; sequestering agents; acidulants; buffers; food acids; preservatives; processing aids, such as emulsifiers; antioxidants, such as butylated hydroxytoluene, butylated hydroxyanisole, and the like; as well as vitamins and minerals.

Sequestering agents are often used to control the concentration of radical species (e.g., Cu⁺⁺, Fe.⁺⁺), which can have a deleterious effect on the color of the filling. A common sequestering agent is an alkali metal pyrophosphate, such as sodium acid pyrophosphate.

Acidulants, such as citric, acetic, tartaric and phosphoric acids can also provide pH control, and function in other capacities as well. For example, citric acid, in addition to being useful for pH control, can also be used to activate potassium sorbate for mold control, to counter the alkalinity of cocoa used in a chocolate formulation, and to impart a tart flavor to the filling.

The third component of the sweet rolls of the present invention is icing. Icing is conventionally a very sweet material that is applied to the sweet roll after baking. It typically is packaged separately from the dough and/or filling component, and is not in contact with these other components during long term storage. Thus, the selection of water activity of the icing is not as critical as for the other components, except that the icing should be of a similar water activity for short term compatibility, and also desirably is not higher than about 0.85 for storage purposes. The icing is preferably formulated so that it does not exhibit separation or syruping during frozen storage or under abusive storage conditions wherein the product is subject to freeze-thaw cycling.

The icing is a non-emulsion based flavor imparting coating composition comprising a fat, a starch, a sweetener, water, viscosity modifiers and optional additional flavorant. Other additives that may optionally be utilized in the icing of the present invention include, for example: salt; whiteners, such as titanium dioxide; anti-microbial agents, such as potassium sorbate, sorbic acid, dehydroacetic acid, sodium benzoate, and the like; sequestering agents; acidulants; buffers; food acids; preservatives; processing aids, such as emulsifiers; antioxidants, such as butylated hydroxytoluene, butylated hydroxyanisole, and the like; as well as vitamins and minerals. Thus, the icing formulation is somewhat similar to the filling formulation, except that it is generally of higher viscosity to retain the icing on top of the warm sweet roll product, and also generally can provide a flavor component that is different from the filling. Icing typically additionally comprises more of the total product weight than the filling, and thus is a higher contributor of sugar in conventional sweet roll products than the filling.

Icing compositions can be formulated in any manner suitable for application to the dough component of the desired sweet roll product, as will now be understood by the skilled artisan. Examples of icing compositions that can optionally be reformulated to provide sweetness from a three part system as described herein are disclosed in U.S. Pat. No. 6,368,645.

The sweetener to be used in an icing is conventionally sugar. However, in the product of the present invention, an embodiment comprises formulating the icing to reduce or eliminate the amount of sugar in the icing. It has been found that the sweetness of the icing component of the sweet roll product can be provided at least in part by a non-nutritive sweet flavorant in combination with at least (i) one sugar alcohol having a molecular weight less than about 350 and (ii) at least one polydextrose, or (i) one sugar alcohol having a molecular weight from about 100 to about 300 and (ii) at least one sugar alcohol having a molecular weight from about 300 to about 350. This balance of ingredients surprisingly affords both the desired flavor and water activity properties of this component of the sweet roll product. Because sugar conventionally is such a large portion of the icing component, the desired balance of water activity and organoleptic properties necessitates use of an at least three part system as noted here to provide the desired sweetness properties.

In selected embodiments of the present invention, the sugar alcohol is selected from the group consisting of erythritol, glycerol, propylene glycol, xylitol, mannitol, sorbitol, maltitol and lactitol.

In a particularly preferred embodiment, the sugar alcohol comprises maltitol. It has been found that this sugar alcohol in particular affords the most effective combination of flavor and water activity control when used in combination with a non-nutritive sweet flavorant and polydextrose.

Particular icing embodiments are compositions that comprise 25-45% maltitol, 10-45% polydextrose, 0.01-0.4% non-nutritive sweetener, 5-20% fat, 1-25% water, 0.1-5% flavor, and 10-35% starch.

By reduction or elimination of sugar from any or all components of the sweet roll product using the formulations of the present invention, the sweet roll product can in one embodiment be configured so as to comprise less than or equal to about 6.50 g of sugar per 55 g sweet roll product serving. This embodiment provides substantial benefit in presenting a low calorie sweet roll product having desired organoleptic properties. In another embodiment, the sweet roll product is configured so as to comprise less than or equal to about 3.25 g of sugar per 55 g sweet roll product serving. In another embodiment, the sweet roll product is configured so as to comprise less than or equal to about 0.50 g of sugar per 55 g sweet roll product serving.

In another aspect of the present invention, the sweet roll product can be formulated to have a substantial reduction of sugar as compared to a conventional sweet roll product. In one embodiment, the dough component comprises less than about 6.5% sugar by weight of all dough ingredients. In another embodiment, the dough component comprises less than about 0.5% sugar by weight of all dough ingredients. In another embodiment, the filling component comprises less than about 20% sugar by weight of all filling ingredients. In another embodiment, the filling component comprises less than about 0.5% sugar by weight of all filling ingredients. In another embodiment, the icing component comprises less than about 25% sugar by weight of all icing ingredients. In another embodiment, the icing component comprises less than about 0.5% sugar by weight of all icing ingredients.

As noted above, because the filling and icing components of conventional sweet rolls tend to contain more sugar than other components, a substantial benefit in sugar and/or calorie reduction can particularly be obtained by using the formulations described herein for use in in these components of the present invention.

In another embodiment of the present invention, the sweet roll product is formulated so that the sweet roll has less than or equal to about 5 fat grams per 55 g sweet roll product serving.

In product preparation, dough is prepared and provided in a desired configuration for application of the filling thereto. The dough with a filling so applied is then optionally further manipulated to configure the product, and then to place the product in packaging for long term storage, either by refrigeration or freezing. The manner in which the fillings of the present invention are applied to doughs to provide dough products is not critical, and will depend on the desired configuration of the dough product. That is, the filling can be provided on the surface of the dough, e.g., as to provide a Bismarck. Also, the filling may be rolled into the dough, so that the filling is distributed in a torroidal pattern substantially within the resulting dough product, so as to provide, e.g., a cinnamon roll. Alternatively, the filling may be substantially enclosed within the dough so as to provide, e.g., a filled croissant, a filled doughnut, and the like. The invention is not restricted to the particularly mentioned configurations, rather, other known or developed configurations are also contemplated.

Sweet roll products of the present invention find particular benefit when provided in configurations that are contemplated to be in storage for prolonged periods of time, e.g., as refrigerated (stored at a temperature of from about 35° F. to about 45° F.) or frozen (stored at a temperature of about 10° F. or less) dough products.

The sweet roll of the present invention is in one embodiment provided in a format suitable for refrigeration. In one embodiment, the sweet roll is provided in a container such as disclosed in U.S. Pat. No. 3,851,757 to Turpin. This patent describes a multiple compartment container having a cylindrical container portion with a closed end and an open end opposite the closed end. A cup is inserted into the open end of the cylindrical container portion and is filled with a desired product. Next, a separator plate is placed over the cup and dough is inserted into the cylindrical container portion. The cylindrical container portion is then sealed and the dough is proofed. Proofing causes the dough to expand in the container and to force the separator plate against the cup to prevent the product in the cup from mixing with the dough.

Another multiple compartment container for packaging incompatible food components is described in the Parlour patent, U.S. Pat. No. 3,506,459. In this patent, a cylindrical container has a first end and a second end opposite the first end. The first end includes a closure element that includes a circular lip that defines a central opening to the cylindrical container. A cup having a main body and a flange at an end of the main body is inserted into the first end of the cylindrical container. The flange permits the main body of the cup to pass through the central opening of the cylindrical container but prevents the cup from passing through the lip of the closure element. A separating plate is positioned over the cup to cover the cup. A seal formed between the lip of the closure element of the cylindrical container and the flange of the cup allows gas to escape from the container while dough undergoes a proofing step and expands.

Another multiple compartment package suitable for use in packaging the present sweet rolls is described in U.S. Pat. No. 5,447,236 to Perry et. al. This packaging includes a first compartment portion, a second compartment portion, and a retaining mechanism for retaining the first compartment portion in close relation to the second compartment portion.

In another embodiment, the sweet roll products according to the invention are provided in frozen form, and packaged for shipping to the intermediate manufacturer or consumer. In some embodiments, the sweet roll products are provided as “freezer-to-oven” sweet roll products, where the consumer does not have to thaw the sweet roll products before placing the dough products into the oven. In these embodiments, the consumer simply removes the sweet roll pieces from the freezer and places the dough pieces directly into the oven. These embodiments may provide advantageous time savings to the consumer, who does not have to thaw the individual dough pieces before baking.

Once a dough product in accordance with the present invention has been prepared, it advantageously may be stored for a prolonged period of time, i.e., for up to 90 days or more at refrigerated temperatures or lower, without suffering a substantial degradation in the quality of the filling, dough or overall dough product. In particular, even though fillings of the present invention are very moist, no substantial moisture migration of any significance occurs between the filling and the dough product; there is no substantial color degradation of the filling; and there is little to no sogginess in the dough product that is filled. Importantly, structural integrity is also preserved, with very little or no filling leakage exhibited.

The invention will further be described by reference to the following nonlimiting examples.

### EXAMPLES

| | Component: | | | | | |
|---|---|---|---|---|---|---|
| | Dough | | Filling | | Icing | |
| Ideal Aw Range | 0.88-0.93 | | 0.84-0.88 | | 0.79-0.83 | |
| Sample Levels: | 67-75% | | 6-12% | | 18-22% | |
| | | % | | % | | % |
| Example 1: | Flour | 53.39 | Shortening, emulsified | 35.00 | Maltitol, Granular | 34.50 |
| 100% Sugar Free | Water | 27.90 | Maltitol Liquid | 22.60 | Polydextrose Liquid | 32.80 |
| | Shortening | 3.00 | Polydextrose Liquid | 15.00 | Starch, wheat | 19.70 |
| | Starch, Wheat | 1.00 | Water | 10.00 | Shortening | 7.20 |
| | Gluten | 1.40 | Cinnamon | 5.00 | Water | 4.80 |
| | Emulsifier | 0.60 | Flavor | 1.55 | Salt | 0.50 |
| | Gum | 0.10 | Hydrocolloid Gum | 0.75 | Flavor, Color | 0.30 |
| | Flavor | 2.40 | Erythritol | 10.00 | Emulsifier | 0.07 |
| | Leavening | 2.40 | Sweetener | 0.10 | Sorbate | 0.03 |
| | Salt | 1.30 | | 100.00 | Sweetener | 0.10 |
| | Erythritol | 6.50 | | | | 100.00 |
| | Sweetener | 0.01 | | | | |
| | | 100.00 | | | | |
| Example 2: | Flour | 53.39 | Shortening, emulsified | 35.00 | Maltitol, Granular | 34.50 |
| 100% Sugar Free | Water | 27.90 | Maltitol, Granular | 14.90 | Polydextrose Liquid | 32.80 |
| | Shortening | 3.00 | Polydextrose Liquid | 15.00 | Starch, wheat | 19.70 |
| | Starch, Wheat | 1.00 | Water | 17.70 | Shortening | 7.20 |
| | Gluten | 1.40 | Cinnamon | 5.00 | Water | 4.80 |
| | Emulsifier | 0.60 | Flavor | 1.55 | Salt | 0.50 |
| | Gum | 0.10 | Hydrocolloid Gum | 0.75 | Flavor, Color | 0.30 |
| | Flavor | 2.40 | Erythritol | 10.00 | Emulsifier | 0.07 |
| | Leavening | 2.40 | Sweetener | 0.10 | Sorbate | 0.03 |
| | Salt | 1.30 | | 100.00 | Sweetener | 0.10 |
| | Erythritol | 6.50 | | | | 100.00 |
| | Sweetener | 0.01 | | | | |
| | | 100.00 | | | | |
| Example 3: | Flour | 53.80 | Shortening, emulsified | 35.00 | Maltitol, Granular | 34.50 |
| 75% Reduced | Water | 28.89 | Sugar | 34.10 | Polydextrose Liquid | 32.80 |
| Sugar | Shortening | 3.00 | Corn Syrup | 14.80 | Starch, wheat | 19.70 |
| | Gluten | 1.00 | Water | 10.00 | Shortening | 7.20 |
| | Emulsifier | 0.60 | Cinnamon | 4.85 | Water | 4.80 |
| | Gum | 0.10 | Flavor | 0.50 | Salt | 0.50 |
| | Flavor | 2.40 | Hydrocolloid Gum | 0.75 | Flavor, Color | 0.30 |
| | Leavening | 2.40 | | 100.00 | Emulsifier | 0.07 |
| | Salt | 1.30 | | | Sorbate | 0.03 |
| | Erythritol | 6.50 | | | Sweetener | 0.10 |
| | Sweetener | 0.01 | | | | 100.00 |
| | | 100.00 | | | | |
| Example 4: | Flour | 53.80 | Shortening, emulsified | 35.00 | Maltitol, Granular | 34.50 |
| 75% Reduced | Water | 28.90 | Maltitol Liquid | 22.60 | Polydextrose Liquid | 32.80 |
| Sugar | Shortening | 3.00 | Polydextrose Liquid | 15.00 | Starch, wheat | 19.70 |
| | Gluten | 1.00 | Water | 10.00 | Shortening | 7.20 |
| | Emulsifier | 0.60 | Cinnamon | 5.00 | Water | 4.80 |
| | Gum | 0.10 | Flavor | 1.55 | Salt | 0.50 |
| | Flavor | 2.40 | Hydrocolloid Gum | 0.75 | Flavor, Color | 0.30 |
| | Leavening | 2.40 | Erythritol | 10.00 | Emulsifier | 0.07 |
| | Salt | 1.30 | Sweetener | 0.10 | Sorbate | 0.03 |
| | Sugar | 6.50 | | 100.00 | Sweetener | 0.10 |
| | | 100.00 | | | | 100.00 |
| Example 5: | Flour | 53.80 | Shortening, emulsified | 35.00 | Maltitol, Granular | 34.50 |
| 50% Reduced | Water | 28.90 | Sugar | 34.10 | Polydextrose Liquid | 32.80 |
| Sugar | Shortening | 3.00 | Corn Syrup | 14.80 | Starch, wheat | 19.70 |
| | Gluten | 1.00 | Water | 10.00 | Shortening | 7.20 |
| | Emulsifier | 0.60 | Cinnamon | 4.85 | Water | 4.80 |
| | Gum | 0.10 | Flavor | 0.50 | Salt | 0.50 |
| | Flavor | 2.40 | Hydrocolloid Gum | 0.75 | Flavor, Color | 0.30 |
| | Leavening | 2.40 | | 100.00 | Emulsifier | 0.07 |
| | Salt | 1.30 | | | Sorbate | 0.03 |
| | Sugar | 6.50 | | | Sweetener | 0.10 |
| | | 100.00 | | | | 100.00 |
| Example 6: | Flour | 53.39 | Shortening, emulsified | 35.00 | Sugar | 56.50 |
| 50% Reduced | Water | 27.90 | Maltitol Liquid | 22.60 | Water | 14.40 |
| Sugar | Shortening | 3.00 | Polydextrose Liquid | 15.00 | Starch, Wheat | 14.20 |
| | Starch, Wheat | 1.00 | Water | 10.00 | Shortening | 7.20 |
| | Gluten | 1.40 | Cinnamon | 5.00 | Corn Syrup Solids | 2.00 |
| | Emulsifier | 0.60 | Flavor | 1.55 | Flavor | 0.60 |
| | Gum | 0.10 | Hydrocolloid Gum | 0.75 | Emulsifiers | 0.10 |
| | Flavor | 2.40 | Erythritol | 10.00 | Whey | 5.00 |
| | Leavening | 2.40 | Sweetener | 0.10 | | 100.00 |
| | Salt | 1.30 | | 100.00 | | |
| | Erythritol | 6.50 | | | | |
| | Sweetener | 0.01 | | | | |
| | | 100.00 | | | | |
| Example 7: | Flour | 53.80 | Shortening, emulsified | 35.00 | Sugar | 56.50 |
| 25% Reduced | Water | 28.90 | Maltitol Liquid | 22.60 | Water | 14.40 |
| Sugar | Shortening | 3.00 | Polydextrose Liquid | 15.00 | Starch, Wheat | 14.20 |
| | Gluten | 1.00 | Water | 10.00 | Shortening | 7.20 |
| | Emulsifier | 0.60 | Cinnamon | 5.00 | Corn Syrup Solids | 2.00 |
| | Gum | 0.10 | Flavor | 1.55 | Flavor | 0.60 |
| | Flavor | 2.40 | Hydrocolloid Gum | 0.75 | Emulsifiers | 0.10 |
| | Leavening | 2.40 | Erythritol | 10.00 | Whey | 5.00 |
| | Salt | 1.30 | Sweetener | 0.10 | | 100.00 |
| | Sugar | 6.50 | | 100.00 | | |
| | | 100.00 | | | | |
| Example 8: | Flour | 51.60 | Shortening, emulsified | 35.00 | Sugar | 56.50 |
| Not Reduced | Water | 27.60 | Sugar | 34.10 | Water | 14.40 |
| Sugar | Shortening | 3.00 | Corn Syrup | 14.80 | Starch, Wheat | 14.20 |
| (Comparative) | Gluten | 1.00 | Water | 10.00 | Shortening | 7.20 |
| | Emulsifier | 0.60 | Cinnamon | 4.85 | Corn Syrup Solids | 2.00 |
| | Gum | 0.10 | Flavor | 0.50 | Flavor | 0.60 |
| | Flavor | 2.40 | Hydrocolloid Gum | 0.75 | Emulsifiers | 0.10 |
| | Leavening | 2.40 | | 100.00 | Whey | 5.00 |
| | Salt | 1.30 | | | | 100.00 |
| | Sugar | 10.00 | | | | |
| | | 100.00 | | | | |

### Examples of Sugar Ranges

Let X=Sugar in Dough (g)

Let Y=Sugar in Filling (g)

Let Z=Sugar in Icing (g)

For a 55 g Sweet Roll, X+Y+Z should be:

| | | |
|---|---|---|
| For 100% Sugar Free | <0.50 | g sugar |
| For 75% Reduced Sugar | ≦3.25 | g sugar |
| For 50% Reduced Sugar | ≦6.50 | g sugar |
| For 25% Reduced Sugar | ≦9.75 | g sugar |
| For Not Reduced Sugar (Control) | ≦13.00 | g sugar |

| | Approx g | | | | Dough + Filling + | |
|---|---|---|---|---|---|---|
| Example | sugar/55 g | Dough | Filling | Icing | Icing | |
| # | roll for | X | Y | Z | X + Y + Z | |
| 1, 2 | 100% Sugar Free | 0 | 0 | 0 | <0.50 | g |
| 3 | 75% Reduced Sugar | 0 | ≦2.8 | 0 | ≦3.25 | g |
| 4 | 75% Reduced Sugar | ≦3.0 | 0 | 0 | ≦3.25 | g |
| 5 | 50% Reduced Sugar | ≦3.0 | ≦2.8 | 0 | ≦6.50 | g |
| 6 | 50% Reduced Sugar | 0 | 0 | ≦6.5 | ≦6.50 | g |
| 7 | 25% Reduced Sugar | ≦3.0 | 0 | ≦6.5 | ≦9.75 | g |
| 8 | Not Reduced in | 4.1 | 2.5 | 6.4 | 13.0 | g |
| | Sugar (Comparative) | (3.9-4.3) | (1.8-2.8) | (5.9-7.0) | | |

### Example 9

An additional example of a sugar reduced filling is provided, wherein the filling does not comprise polydextrose.

| | |
|---|---|
| Shortening, emulsified | 34.00 |
| Maltitol Liquid | 38.00 |
| Polydextrose Liquid | 0.00 |
| Water | 11.60 |
| Cinnamon | 5.00 |
| Flavor | 1.55 |
| Hydrocolloid Gum | 0.75 |
| Erythritol | 9.00 |
| Sweetener | 0.10 |
| | 100.00 |

### Example 10

An additional example of a sugar reduced icing is provided, wherein the icing does not comprise polydextrose.

| | |
|---|---|
| Maltitol, Granular | 34.508. |
| Maltitol, Liquid | 70 |
| Erythritol | 5.00 |
| Polydextrose Liquid | 0 |
| Starch, wheat | 30.00 |
| Shortening | 7.20 |
| Water | 13.60 |
| Salt | 0.50 |
| Flavor, Color | 0.30 |
| Emulsifier | 0.07 |
| Sorbate | 0.03 |
| Sweetener | 0.10 |
| | 100.00 |

### Example 11

An example of a filling with no erythritol is provided, which has been found to be useful for use in frozen sweet roll products. This filling does not contain erythritol.

| | |
|---|---|
| Shortening, emulsified | 35.00 |
| Maltitol Liquid | 28.50 |
| Polydextrose Liquid | 19.10 |
| Water | 10.00 |
| Cinnamon | 5.00 |
| Flavor | 1.55 |
| Hydrocolloid Gum | 0.75 |
| Sweetener | 0.10 |
| | 100.00 |

All patents, patent documents, and publications cited herein are incorporated by reference as if individually incorporated. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the embodiments specifically listed below.

1. A sweet roll product comprising
(a) a dough component having a first water activity;
(b) a non-emulsion based, moisture-containing filling component comprising at least two water activity impacting ingredients and having a second water activity, and
(c) an icing component;
wherein the first water activity is greater than or equal to the second water activity, and the second water activity is at least about 0.725;
the sweet roll product comprises less than or equal to about 9.75 g of sugar per 55 g sweet roll product serving; and
at least a portion of the sweetness of the sweet roll product is provided by a non-nutritive sweet flavorant provided in combination with at least one sugar alcohol having a molecular weight less than about 350; and
when at least a portion of the sweetness of the sweet roll product is provided by a non-nutritive sweet flavorant in the filling component, the non-nutritive sweet flavorant is provided in combination with at least (i) one sugar alcohol having a molecular weight from about 100 to about 300 and (ii) at least one sugar alcohol having a molecular weight from about 300 to about 350 and/or at least one polydextrose; and
when at least a portion of the sweetness of the sweet roll product is provided by a non-nutritive sweet flavorant in the icing component, the non-nutritive sweet flavorant is provided in combination with at least (i) one sugar alcohol having a molecular weight less than about 350 and (ii) at least one polydextrose, or (i) one sugar alcohol having a molecular weight from about 100 to about 300 and (ii) at least one sugar alcohol having a molecular weight from about 300 to about 350.

2. The sweet roll product of claim 1, wherein the sweet roll product comprises less than or equal to about 6.50 g of sugar per 55 g sweet roll product serving.

3. The sweet roll product of claim 1, wherein the sugar alcohol is selected from the group consisting of erythritol, glycerol, propylene glycol, xylitol, mannitol, sorbitol, maltitol and lactitol.

4. The sweet roll product of claim 1, wherein the sugar alcohol comprises erythritol.

5. The sweet roll product of claim 1, wherein the icing component has a water activity of about 0.79 to about 0.83.

6. The sweet roll product of claim 1, wherein at least a portion of the sweetness of the dough component is provided by a non-nutritive sweet flavorant provided in combination with erythritol.

7. The sweet roll product of claim 1, wherein at least a portion of the sweetness of the filling component is provided by a non-nutritive sweet flavorant provided in combination with maltitol and erythritol.

8. The sweet roll product of claim 1, wherein at least a portion of the sweetness of the filling component is provided by a non-nutritive sweet flavorant provided in combination with maltitol, polydextrose and erythritol.

9. The sweet roll product of claim 1, wherein at least a portion of the sweetness of the icing component is provided by a non-nutritive sweet flavorant provided in combination with maltitol and polydextrose.

10. The sweet roll product of claim 1, wherein the dough component comprises less than about 0.5% sugar by weight of all dough ingredients.

11. The sweet roll product of claim 1, wherein the filling component comprises less than about 0.5% sugar by weight of all filling ingredients.

12. The sweet roll product of claim 1, wherein the icing component comprises less than about 0.5% sugar by weight of all icing ingredients.

13. The sweet roll product of claim 1, wherein the sweet roll product is a refrigerated sweet roll product.

14. The sweet roll product of claim 1, wherein the sweet roll product is a frozen sweet roll product.

15. A sweet roll product intermediate, comprising
(a) a dough component having a first water activity; and
(b) a non-emulsion based, moisture-containing filling component comprising at least two water activity impacting ingredients and having a second water activity,
wherein the first water activity is greater than or equal to the second water activity, and the second water activity is at least about 0.725; and
at least a portion of the sweetness of the sweet roll product is provided by a non-nutritive sweet flavorant provided in combination with at least one sugar alcohol having a molecular weight less than about 350; and
when at least a portion of the sweetness of the sweet roll product intermediate is provided by a non-nutritive sweet flavorant provided in combination with at least one sugar alcohol having a molecular weight less than about 350 in the filling component, the non-nutritive sweet flavorant is provided in combination with at least (i) one sugar alcohol having a molecular weight from about 100 to about 300 and (ii) at least one sugar alcohol having a molecular weight from about 300 to about 350 and/or at least one polydextrose.

16. The sweet roll intermediate product of claim 15, wherein when at least a portion of the sweetness of the sweet roll product intermediate is provided by a non-nutritive sweet flavorant provided in combination with at least one sugar alcohol having a molecular weight less than about 350 in the filling component, the non-nutritive sweet flavorant is provided in combination with at least (i) one sugar alcohol having a molecular weight from about 100 to about 300 and (ii) at least one polydextrose.

17. The sweet roll intermediate product of claim 15, wherein the sweet roll intermediate product comprises less than or equal to about 0.50 g of sugar per 55 g sweet roll intermediate product serving.

18. The sweet roll intermediate product of claim 15, wherein the sweet roll intermediate product is a refrigerated sweet roll product.

19. A frozen sweet roll product intermediate, comprising
(a) a dough component having a first water activity; and
(b) a non-emulsion based, moisture-containing filling component comprising at least two water activity impacting ingredients and having a second water activity,
wherein the first water activity is greater than or equal to the second water activity, and the second water activity is at least about 0.725; and
at least a portion of the sweetness of the sweet roll product is provided by a non-nutritive sweet flavorant provided in combination with at least one sugar alcohol having a molecular weight less than about 350; and
when at least a portion of the sweetness of the sweet roll product is provided by a non-nutritive sweet flavorant in the filling component, the non-nutritive sweet flavorant is provided in combination with at least (i) one sugar alcohol having a molecular weight from about 100 to about 300 and (ii) at least one sugar alcohol having a molecular weight from about 300 to about 350 and/or at least one polydextrose, or at least (i) one sugar alcohol having a molecular weight from about 300 to about 350 and (ii) polydextrose.

20. A frozen sweet roll product comprising the frozen sweet roll intermediate of claim 19, and additionally comprising an icing.
